(19) United States
(12) Patent Application Publication
(10) Pub. No.: US 2006/0062946 A1
(43) Pub. Date: Mar. 23, 2006

(54) Multiply polyolefin sheet, method for making same and related use

(75) Inventors: Ekkhard Beer, Bad Schwalbach (DE); Wolfram Goerlitz, Wiesbaden (DE); Bernd Hoecker, Eltville-Rauenthal (DE)

Correspondence Address: CONNOLLY BOVE LODGE & HUTZ, LLP, P O BOX 2207, WILMINGTON, DE, 19899, US

(73) Assignee: TICONA GMBH, KELSTERBACH (DE)

(21) Appl. No.: 10/524,649

(22) PCT Filed: Aug. 19, 2003
(86) PCT No.: PCT/EP03/09156

§ 371 Date: Apr. 11, 2005

(30) Foreign Application Priority Data
Aug. 21, 2002 (DE) 102 38 516.5

(51) Int. Cl. B32B 27/10

(52) U.S. Cl. 428/34.2

(57) ABSTRACT

The invention relates to a multilayer polyolefin film composed of at least three layers, comprising a) a core layer A functioning as base layer and composed of at least one amorphous polyolefin or of a mixture of at least one semicrystalline polyolefin and 5.0% by weight or more of at least one amorphous polyolefin and b) on the two sides, outer layers B and C, which are identical or different, composed of a polyolefin (polyethylene, polypropylene) and/or a mixture composed of polypropylene and of an amorphous polyolefin. The films of the invention have very good thermoformability together with low shrinkage. The chemical structure of the core layer A gives exceptionally low water absorption and superior barrier action with respect to water vapor. The invention further relates to the use of this film and to a process for its production.

The invention relates to a multilayer polyolefin film composed of at least three layers, comprising a) a core layer A functioning as base layer and composed of at least one amorphous polyolefin or of a mixture of at least one semicrystalline polyolefin and 5.0% by weight or more of at least one amorphous polyolefin and b) on the two sides, outer layers B and C, which are identical or different, composed of a polyolefin (polyethylene, polypropylene) and/or a mixture composed of polypropylene and of an amorphous polyolefin. The films of the invention have very good thermoformability together with low shrinkage. The chemical structure of the core layer A gives exceptionally low water absorption and superior barrier action with respect to water vapor. The invention further relates to the use of this film and to a process for its production.

Films intended for utilization in deep thermoforming applications have to comply with certain properties in relation to processability on packaging machinery, and also in relation to their barrier properties with respect to atmospheric gases, such as oxygen, and moreover in relation to a high level of barrier action with respect to water vapor. Furthermore, high film stiffness is demanded for thermoforming, in particular for deep-thermoforming applications, for reasons of processability and runnability. After deep thermoforming, the film should therefore have no thick or thin areas in its profile, because these can generally lead to a reduction in the level of barrier action with respect to gases and water vapor. In the case of blister film structures, this requirement has to be heeded in particular in the transitional area, i.e. at the corners between the base and the side of the blister. Even a very slight change in the wall thickness here can have a marked effect on the level of barrier action.

It is generally difficult or impossible to provide adequate compliance with these end-use-generated requirements using homopolymers alone, or using polymer blends, because none of the currently available plastics in itself provides this type of combination of all of the properties demanded. No technical or economic solution can therefore be achieved using just one single material. For example, materials such as EVOH-containing films with a good gas barrier may have an inadequate water-vapor barrier, and indeed require additional protection because they are hygroscopic and when moist cannot develop the desired level of barrier action with respect to oxygen. Other polymers, such as polyamide, do not achieve the desired properties in films, or achieve them only at or above a certain layer thickness required, for example, for compliance with the barrier values demanded from a film. The prior art generally solves this problem via various types of composites of multilayer films.

Furthermore, films used in the packaging sector are often required to have sealability with a low minimum sealing temperature, to give cost-effective processing on packaging machinery.

Multilayer films, in particular three-layer films, in which the central base layer is composed of amorphous polyolefin or of a mixture composed of amorphous polyolefin and of polyolefins, are known. The outer layers on the two sides may be composed of LDPE (DE 198 28 867, TICONA), of unoriented PP (DE 198 28 857, TICONA), of crystallized polyolefin (EP 0631864, TASAI), or of a mixture composed of PP and of an ethylene-α-olefin copolymer (EP0920989, Mitsui). The bonding of the layers takes place via coextrusion or with the aid of an adhesive layer. A disadvantage in the application of these films is that the processing latitude is too narrow, i.e. the glass transition temperature T_{g} of the base layer has not been matched to the outer layer material. The result is that the latter cannot play an ideal part in the orienting process, and that use of a three-layer film, as pharmaceutical blister film, for example, is restricted or unsuccessful.

It is an object of the present invention to eliminate the disadvantages of the prior art.

The invention provides a multilayer polyolefin film composed of at least three layers, comprising 1) a) a core layer A functioning as base layer and composed of at least one amorphous polyolefin and b) on the two sides, outer layers B and C composed of a mixture composed of polypropylene and of at least one amorphous polyolefin, or II a) a core layer A composed of a mixture of at least one semicrystalline polyolefin and 5.0% by weight or more of at least one amorphous polyolefin, and b) two outer layers B and C which are identical or different, composed of a semicrystalline polyolefin and/or of a mixture composed of polypropylene and of at least one amorphous polyolefin. The invention further relates to the use of this film and to a process for its production.

For the purposes of the invention, amorphous polyolefins are cycloolefin copolymers (COCs) and cycloolefinic polymers (COPs), individually or in the form of a mixture. Suitable cycloolefin copolymers are known per se and are described in EP-A-0 407 870, EP-A-0 485 893, EP-A-0 503 422, and DE-A-40 36 264, incorporated herein by way of reference.

The cycloolefin copolymers used are composed of one or more cycloolefins, the cycloolefins generally used comprising substituted and unsubstituted cycloalkenes and/or polycycloalkenes, e.g. bi-, tri-, or tetracycloalkenes. The cycloolefin copolymers may also have branching. Products of this type may have a comb structure or star structure. Advantageous materials are copolymers composed of ethylene and/or of an α-polyolefin with one or more cyclic, bicyclic, and/or polycyclic olefins. A particularly advantageous material is the amorphous polyolefin derived from at least one of the cyclic or polycyclic olefins of the following formulae I, II, II′, III, IV, V, VI 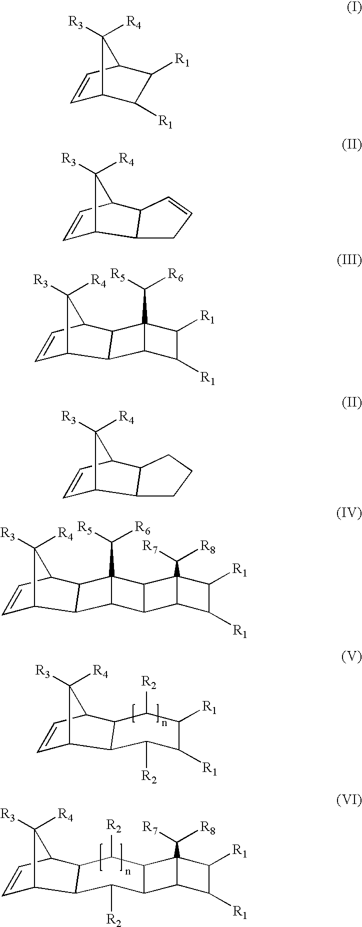
where R¹, R², R³, R⁴, R⁵, R⁶, R⁷, and R⁸ are identical or different and are a hydrogen atom or a C₁-C₂₀-hydrocarbon radical, such as a linear or branched C₁-C₈-alkyl radical, C₆-C₁₈-aryl radical, or C₇-C₂₀-alkylenearyl radical, or a cyclic or acyclic C₂-C₂₀-alkenyl radical, or form a saturated, unsaturated, or aromatic ring, where identical radicals R¹ to R⁸ have a different meaning in the various formulae I to VI, and where n assumes values from 0 to 5, and from 0 to 99.9% by weight, preferably from 0.1 to 99.9% by weight, based on the total weight of the cycloolefin copolymer, of polymerized units which derive from one or more acyclic olefins of the formula VII 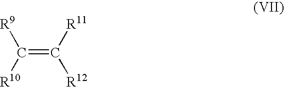
where R⁹, R¹⁰, R¹¹, and R¹² are identical or different and are a hydrogen atom, a linear, branched, saturated or unsaturated C₁-C₂₀-hydrocarbon radical, such as a C₁-C₈-alkyl radical or a C₆-C₁₈-aryl radical.

The cycloolefin copolymers used may moreover comprise from 0 to 45% by weight, based on the total weight of the cycloolefin copolymer, of polymerized units which derive from one or more monocyclic olefins of the formula VIII 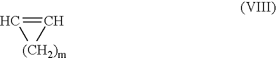
where m is a number from 2 to 10.

Among the cyclic olefins are also derivatives of these cyclic olefins having polar groups, such as halogen groups, hydroxy groups, ester groups, alkoxy groups, carboxy groups, cyano groups, amido groups, imido groups, or silyl groups.

For the purposes of the invention, preference is given to cycloolefin copolymers which contain polymerized units which derive from polycyclic olefins of the formulae I or III, and contain polymerized units which derive from acyclic olefins of the formula VII, in particular olefins having an underlying norbornene structure, e.g. norbornene and tetracyclododecene and, if appropriate, vinylnorbornene or norbornadiene.

Preference is also given to cycloolefin copolymers having polymerized units derived from acyclic olefins having terminal double bonds, for example α-olefins having from 2 to 20 carbon atoms, in particular ethylene or propylene, e.g. norbornene-ethylene copolymers and tetracyclododecene-ethylene copolymers.

Preferred terpolymers are norbornene-vinylnorbornene-ethylene terpolymers, norbornene-norbornadiene-ethylene terpolymers, tetracyclo-dodecene-vinylnorbornene-ethylene terpolymers, tetracyclododecene-vinyltetracyclododecene-ethylene terpolymers, or norbornene-dicyclo-pentadiene-ethylene terpolymers.

An amorphous polyolefin which may be used with very particular advantage is a copolymer composed of ethylene and norbornene.

During the processing of the film of the invention it has been found that a compromise has to be adopted here between its formability and the level of barrier action. For example, a film with an amorphous polyolefin whose T_{g} is high has a poorer level of barrier action than a film with an amorphous polyolefin with a low T_{g}. However, it can be formed more uniformly to give the blister, the overall result therefore being a better processing profile and greater processing latitude on the appropriate processing machinery. This applies in particular when the outer layers, for example comprising polypropylene, are thick in comparison to the total thickness of the film, for example ≧30 μm for a film thickness of from 200 to 400 μm.

The processing temperature of the film is therefore determined via the material of the outer layers. The T_{g} of the material of the core layer A is in turn selected as a function of the thickness of the outer layers, and this means that thin outer layers allow a material to have a lower T_{g} and thick outer layers allow a material to have a relatively high T_{g}. This conclusion can be expressed in an empirical equation:
T_{g(A)}≧total of polyolefin layers(absolute value)/2+65(empirical variable)

The outer layer A may comprise pure COC and blends composed of COC of high and low T_{g}, if appropriate mixed with polyolefins.

A combination of various polymers in a composite of the invention, achieved via coextrusion or lamination, combines the property profiles of the various polymeric materials with one another in an advantageous manner. The cumulative film layers provide not only the water-vapor barrier needed but also the flexibility and the puncture resistance of the film composite, and specifically together with high transparency and good thermoformability. However, the result is not only an improvement in properties but also a reduction in the cumulative thickness of the entire film structure, thus either obtaining a significant rise in the level of barrier action with respect to water vapor for a given film thickness or bringing about a marked reduction in layer thickness and therefore a cost saving for given property profiles.

It is surprising that admixture of very small proportions of at least one amorphous polyolefin, in particular COC and COP, markedly improves the properties of films composed of a semicrystalline polyolefin, in particular polyethylene, e.g. the stampability of the film, arising from the mechanical stiffness of the amorphous polyolefin used, and eliminates filament-formation at the cut edge of the blister.

In one embodiment of the present invention, the multilayer plastics film comprises outward-facing layers which comprise a blend composed of at least one semicrystalline polyolefin and of at least one amorphous polyolefin. Between the two outward-facing layers, there is advantageously at least one layer which improves adhesion.

The film of the invention features a combination of the following properties:
more uniform wall thickness distribution after thermoforming
very good thermoformability
very low shrinkage after thermoforming
unusually good puncture resistance when exposed to static and/or dynamic load
good barrier properties with respect to water vapor
no change in mechanical properties via absorption of moisture.

An important feature of the core layer A is its very low tensile strain at break.

The shrinkage can moreover be markedly reduced if a mixture of different amorphous polyolefins is used for the core layer A. The thickness of the layer A can moreover be varied widely when mixtures of this type are used.

After analysis of available film structures in relation to the requirements placed upon the packaging, it is possible to design layer structures where available layer materials are replaced by COC or modified by COC and where thickness reductions also become possible. This procedure results in the desired success in relation to barrier properties. Surprisingly, the high stiffness of the COC material (high modulus of elasticity) in the layer structure does not give any noticeable disadvantage in relation to the overall flexibility of the film, and it provides an additional increase in thermoformability and puncture resistance. The result is therefore that the desired properties, e.g. high mechanical stiffness at a given overall flexibility of the film composite, good sealability of the film, and a high water-vapor barrier, can be achieved in an outward-facing layer modified with an amorphous polyolefin, within the film.

The inner layer(s) and the outward-facing layers have either been bonded to one another via direct coextrusion or by means of an adhesion-promoting layer located between the inner layer(s) and the outward-facing layer(s).

These processes may use, between two adjacent layers, another layer which has the function of improving adhesion between the two first-mentioned layers.

The core layer A comprises either an amorphous polyolefin or a mixture composed of at least one semicrystalline polyolefin and of at least one amorphous polyolefin. The mixture may be present not only in the core layer A but also in the outer layers B and C. The proportion of amorphous polyolefin in the core layer A here is ≧5.0% by weight, preferably from 10 to 50% by weight, in particular from 15 to 40% by weight. The proportion of amorphous polyolefin in the outer layers B and C may be lowered as far as 1.0% by weight.

The thickness of the core layer A is generally ≧5 μm, preferably ≧10 μm, and in particular ≧15 μm.

The thickness of the multilayer film of the invention is generally from 50 to 350 μm, preferably from 75 to 275 μm. The thicknesses of the outer layers here make up from 2.5 to 90% of the entire structure.

The outward-facing layer may comprise mineral additives. Conventional mineral additives are materials such as aluminum oxide, aluminum sulfate, barium sulfate, calcium carbonate, magnesium carbonate, silicates, such as aluminum silicate (kaolin clay) and magnesium silicate (talc), silicon dioxide and titanium dioxide, preferred-use materials among these being white pigments, such as calcium carbonate, silicon dioxide, titanium dioxide, and barium sulfate. The titanium dioxide particles are composed of at least 95% by weight of rutile and are preferably used with a coating of inorganic oxides which is the usual coating used for white TiO₂ pigment in papers or paints, to improve lightfastness.

Among the particularly suitable inorganic oxides are the oxides of aluminum, silicon, zinc, or magnesium, and mixtures composed of two or more of these compounds. They are precipitated from water-soluble compounds, e.g. alkali metal aluminate, in particular sodium aluminate, aluminum hydroxide, aluminum sulfate, aluminum nitrate, sodium silicate, or silica, in aqueous suspension.

TiO₂ particles with a coating are described by way of example in EP-A-0 078 633 and EP-A-0 044 515.

Alongside these mineral additives, neutralizing agents, stabilizers, lubricants, hydrocarbon resins, and/or antistatic agents may additionally be present in one or more outward-facing layers of the multilayer film. The data below in percent by weight are based on the weight of the respective layer to which the additive has been added. Neutralizing agents are preferably dihydro talcite, calcium stearate, and/or calcium carbonate of average particle size of at most 0.7 μm, of absolute particle size smaller than 10 μm, and of specific surface area of at least 40 m²/g. The amount of neutralizing agent generally added is from 0.02 to 0.1% by weight.

The stabilizers used may comprise the conventional stabilizing compounds or polymers of ethylene, of propylene, and of other alpha-olefins. The amount added of these is from 0.05 to 2.0% by weight. Particularly suitable materials are phenolic stabilizers, alkali metal/alkaline earth metal stearates, and/or alkali metal/alkaline earth metal carbonates. The amount added of phenolic stabilizers is from 0.1 to 0.6% by weight, preferably from 0.15 to 0.3% by weight, and their molar mass is preferably more than 500 g/mol. Pentaerythrityl tetrakis-3-(3,5-di-tert-butyl-4-hydroxyphenyl)-propionate or 1,3,5-trimethyl-2,4,6-tris(3,5-di-tert-butyl-4-hydroxybenzyl)-benzene are particularly advantageous.

Lubricants are higher aliphatic amides, higher aliphatic esters, waxes, and metal soaps, and also polydimethylsiloxanes. The effective amount of lubricant is in the range from 0.1 to 3.0% by weight. A particularly suitable method is addition of higher aliphatic amides in the range from 0.15 to 0.25% by weight in base layers and/or outward-facing layers.

Preferred antistatic agents are alkali metal alkanesulfonates, polyether-modified, i.e. ethoxylated and/or propoxylated polydiorganosiloxanes (polydialkylsiloxanes, polyalkylphenylsiloxanes and the like) and/or the substantially straight-chain and saturated aliphatic, tertiary amines having an aliphatic radical having from 10 to 20 carbon atoms, substituted with α-hydroxy(C₁-C₄)alkyl groups, particularly suitable compounds being N,N-bis(2-hydroxyethyl)alkylamines having from 10 to 20 carbon atoms, preferably from 12 to 18 carbon atoms, in the alkyl radical. The effective amount of antistatic agent is in the range from 0.05 to 3.0% by weight. Glycerol monostearate is another preferred antistatic agent.

The coating also comprises, if appropriate, organic compounds having polar and non-polar groups. Preferred organic compounds are alkanols and fatty acids having from 8 to 30 carbon atoms in the alkyl group, in particular fatty acids and primary n-alkanols having from 12 to 24 carbon atoms, and also polydiorganosiloxanes and/or polyorganohydrosiloxanes, e.g. polydimethylsiloxane and polymethylhydrosiloxane.

The coating on the TiO₂ particles is usually composed of from 1.0 to 12.0 g, preferably from 2.0 to 6.0 g, of inorganic oxides, other materials present if appropriate being from 0.5 to 3.0 g, in particular from 0.7 to 1.5 g, of organic compounds, in each case based on 100 g of TiO₂ particles. It has proven particularly advantageous for the TiO₂ particles to have a coating of Al₂O₃ or of Al₂O₃ and polydimethylsiloxane.

Addition of sufficient amounts of these substances can also produce a white or opaque embodiment of the film.

The semicrystalline polyolefin used may generally comprise polymers composed of ethylene or of α-olefins, such as propene, n-butene, isobutene, and of higher α-olefins, or may comprise copolymers of these. Use may advantageously be made of polypropylene, polyethylenes, such as HDPE, LDPE and LLDPE, and also of mixtures prepared therefrom. Preference is given to mixtures of LDPE and LLDPE in an unrestricted mixing ratio from 5 to 100%. If appropriate, the semicrystalline polyolefin comprises other additions of additives, in respectively effective amounts. Isotactic polypropylene homopolymer having an atactic section of 15% by weight or less, copolymers of polyethylene and polypropylene having an ethylene content of 10% by weight or less, copolymers of propylene with C₄-C₈ alpha-olefins having an alpha-olefin content of 10% by weight or less, terpolymers of propylene, ethylene, and butylene having an ethylene content of 10% by weight or less and having a butylene content of 15% by weight or less are likewise suitable. The stated percentages by weight are based on the respective polymer.

Amorphous polyolefins are polyolefins which are solid at room temperature despite irregular arrangement of the molecular chains. Particularly suitable amorphous polyolefins are those whose T_{g} is in the range from 60 to 300° C., preferably from 70 to 250° C., in particular from 80 to 200° C., or whose Vicat softening point T_{V} (VST/B/120) is in the range from 70 to 200° C., preferably from 80 to 180° C. The amorphous polyolefin generally has an average molecular weight Mw in the range from 1000 to 500 000, preferably from 1500 to 250 000, in particular from 3000 to 150 000. The refractive index is generally in the range from 1.3 to 1.7, preferably from 1.4 to 1.6. It is particularly advantageous here for the refractive index of the amorphous polyolefin to have a particular ratio to the refractive index of the polyolefin of the outer layer. The refractive indices of amorphous polyolefin and of the polyolefin of the outer layer generally differ by not more than 0.1 units, preferably by not more than 0.05 units. This gives the outward-facing layer high transparency.

The cycloolefin polymers are generally prepared with the aid of transition metal catalysts described in the abovementioned publications. Among these preparation processes, preference is given to those in EP-A-0 407 870 and EP-A-0 485 893, because these processes deliver cycloolefin polymers with narrow molecular weight distribution (Mw/Mn=2). This eliminates disadvantages such as migration, extractability, or tack of the, or resulting from the, low-molecular-weight constituents. The molecular weight is regulated during the preparation process via use of hydrogen, a careful selection of the catalyst and of the reaction conditions.

There are embodiments which have at least one other layer on both sides of the core layer A, comprising an amorphous polyolefin or a mixture composed of at least one semicrystalline polyolefin and of at least one amorphous polyolefin, and of the outer layers on the two sides. If there is more than one other layer, the thickness and constitution of these other layers may be identical or different. These additional layers may have the layers which improve adhesion.

The layer improving adhesion generally comprises at least one or more polymers. Materials advantageously useful for this purpose are, by way of example, polymers of ethylene or of α-olefins, or are copolymers of these, e.g. low-density polyethylene (LDPE), linear low-density polyethylene (LLDPE), polypropylene.

These polyolefins may also be modified. This modified polyolefin may advantageously be present in the adhesion-improving layer and contains from 1 to 50% by weight, based on the total amount of the modified polyolefin plastic, of at least one of the following groups: carboxyl, carboxylic anhydride, metal carboxylate, carboxylic ester, imino, amino or epoxy. Examples of the modified polyolefin plastic include modified polylolefin copolymers or grafted copolymers prepared by chemically introducing compounds such as those in the following list: maleic anhydride, fumaric anhydride, citric anhydride, N-phenylmaleimide, N-cyclohexylmaleimide, glycidyl acrylate, glycidyl methacrylate, glycidyl vinylbenzoate, N-[4-(2,3-epoxypropoxy)-3,5-dimethylbenzyl]acrylamide (AXE), alkyl methacrylate and/or derivatives of these into polyolefins, such as polypropylene, polyethylene or ethylene-propylene copolymers, or into polyamide-grafted polyolefins. There is no limit on the degree of polymerization of the modified polyolefin, and it may also be an oligomer. Particularly preferred modified polyolefins are
maleic-anhydride-modified polyethylene,
maleic-anhydride-modified polypropylene,
maleic-anhydride-modified polyethylene-polypropylene copolymer,
fumaric-anhydride-modified polyethylene,
fumaric-anhydride-modified polypropylene,
fumaric-anhydride-modified polyethylene-polypropylene copolymer,
glycidyl-methacrylate-modified polyethylene,
glycidyi-methacrylate-modified polypropylene,
AXE-modified polyethylene.

It is also possible to use copolymers of ethylene with unsaturated esters, such as vinyl acetate, or to use (meth)acrylic esters, such as ethyl methacrylate, or else to use copolymers of ethylene with vinyl alcohol.

The layer improving adhesion may also comprise polyamide, preferably nylon-6, nylon-11, nylon-12, nylon-6,6, nylon-6,10, nylon-6,12.

These polymers may be used individually or in the form of mixtures.

The layer improving adhesion may advantageously be applied in the melt or else in the form of a solution, suspension, or solvent-containing adhesive.

The invention also provides a process for producing the film of the invention, in which the polymers and/or polymer mixtures forming the film are melted in an extruder, then the melt(s) is/are extruded through a flat-film die, the resultant film is drawn off on one or more rolls, whereupon it cools and solidifies, and then the film is subjected to, if appropriate, a known method of stretching, and/or heat-setting, and/or surface-treatment.

The melt(s) emerging from the extruder may also be extruded via an annular die, whereupon the resultant film is processed in a blown-film system to give the film, collapsed by way of rolls, and is, if appropriate, heat-set and/or surface-treated.

Any additives added may by this stage be present in the polymer or in the polymer mixture, or may be added via masterbatch technology.

Heat-setting (heat-treatment) may then be carried out, the film being kept at a temperature of from 100 to 160° C. for from about 0.5 to 10 s. The film is then wound up in the usual way, using wind-up equipment.

The take-off roll or take-off rolls via which the extruded film is also cooled and solidified is/are mostly kept at a temperature of from 20 to 90° C.

If appropriate, corona- of flame-treatment by one of the known methods may be used on one or both surfaces of the film.

The amorphous polyolefin is used either in the form of pure pellets or in the form of pelletized concentrate (masterbatch) with the semicrystalline polyolefin. The components are mixed and incorporated advantageously by premixing the semicrystalline polyolefin pellets or semicrystalline polyolefin powder with the amorphous polyolefin and then introducing it into the extruder. In the extruder, the components are further mixed and heated to processing temperature. It has been found that the slip properties and the optical properties of the film are also dependent on the extrusion conditions (temperature, shear). Surprisingly, the slip properties and the optical properties of the film can be varied by way of the conditions in the extruder, while other conditions in relation to the raw materials and stretching process are identical. For this process for producing the film of the invention, it is advantageous for the extrusion temperature for the outer layer(s) to be above the glass transition temperature/Vicat softening point (T_{g} or T_{V}) of the amorphous polymer. The extrusion temperature for the outer layer(s) is generally above the T_{g} or the T_{V} of the amorphous polymer by at least 10° C., preferably from 15 to 180° C., in particular from 20 to 150° C.

The properties of the film of the invention—very good thermoformability, very low shrinkage, and relatively uniform wall thickness distribution after thermoforming, and unusually good puncture resistance when exposed to static and/or dynamic load—make it a very highly suitable thermoplastic packaging film, preferably a blister film. Furthermore, because the film has good barrier properties with respect to water vapor, no alteration in mechanical properties occurring via moisture absorption, it can be used in the sectors where it comes into contact with foodstuffs, for example in the packaging industry as a deep-thermoforming film in deep-thermoformed packaging for, by way of example, perishable foods, such as fish products, meat products, poultry products, and sausage products, and for pharmaceutical blister packs. Although wall thickness distribution is better and wall thickness is therefore higher, articles packed in the blister can be removed easily by pressure without any major exertion of force.

The films can moreover be used to produce a laminated article in which the films of the invention are processed together with paper and/or cardboard and/or one or more metal foils and/or other films composed of thermoplastic.

### EXAMPLES

Composite films were produced by the known coextrusion process using a flat-film die, with total thickness of from 220 to 250 μm, composed of three layers, having a core layer A and two outer layers B and C. The individual layers had the thicknesses given in the tables of the examples. The core layer A used thermoplastic olefin polymers of amorphous structure (COCs) based on ethylene and norbornene from Ticona, Germany (®Topas grade 8007 and grade 6013), T_{g} 80° C. and, respectively, 140° C. The semicrystalline polyolefin used comprised polypropylene (density: 0.91 g/cm³).

The composite films were used in a known manner to mold blisters, and the wall thicknesses were measured in the transition area, i.e. at a corner between base and side of the blister.

Composite films whose outer layers comprised pure polypropylene were used as comparison. The mixing ratios and the results obtained are given in tables 1 to 3.

TABLE 1

| | | | Wall |
|---|---|---|---|
| | Outer layers B and C | Core layer A | thickness |
| Example | (60 μm) | (100 μm) | (μm) |
| 1 | 95% PP + 5% COC 8007 | COC 8007 | 63 |
| 2 | 95% PP + 5% COC | 60% COC 8007 + | 72 |
| | (60% COC 8007 | 40% COC 6013 | |
| | and 40% COC 6013) | | |
| 3 | 95% PP + 5% COC | 35% COC 8007 + | 112 |
| | (35% COC 8007 | 65% COC 6013 | |
| | and 65% COC 6013) | | |
| c1 | PP | COC 8007 | 61 |
| c2 | PP | 60% COC 8007 + | 71 |
| | | 40% COC 6013 | |
| c3 | PP | 35% COC 8007 + | 110 |
| | | 65% COC 6013 | |

PP = pure polypropylene
COC = thermoplastic olefin polymers of amorphous structure

TABLE 2

| | | | Wall |
|---|---|---|---|
| | Outer layers B and C | Core layer A | thickness |
| Example | (50 μm) | (130 μm) | (μm) |
| 4 | 95% PP + 5% COC 8007 | COC 8007 | 67 |
| 5 | 95% PP + 5% COC | 60% COC 8007 + | 76 |
| | (60% COC 8007 and | 40% COC 6013 | |
| | 40% COC 6013) | | |
| c4 | PP | COC 8007 | 65 |
| c5 | PP | 60% COC 8007 + | 74 |
| | | 40% COC 6013 | |

TABLE 3

| | | | Wall |
|---|---|---|---|
| | Outer layers B and C | Core layer A | thickness |
| Example | (30 μm) | (190 μm) | (μm) |
| 6 | 95% PP + 5% COC 8007 | COC 8007 | 74 |
| 7 | 95% PP + 5% COC | 60% COC 8007 + | 83 |
| | (60% COC 8007 and | 40% COC 6013 | |
| | 40% COC 6013) | | |
| 8 | 95% PP + 5% COC | 35% COC 8007 + | 82 |
| | (35% COC 8007 and | 65% COC 6013 | |
| | 65% COC 6013) | | |
| c6 | PP | COC 8007 | 72 |
| c7 | PP | 60% COC 8007 + | 80 |
| | | 40% COC 6013 | |
| c8 | PP | 35% COC 8007 + | 80 |
| | | 65% COC 6013 | |

From the results it can be seen that addition of as little as 5% of COC to the semicrystalline polyolefin of the outer layers brings about a marked increase in the wall thickness in the shoulder area of the blister. However, higher wall thickness also means a better level of barrier action with respect to atmospheric gases, and also a higher level of barrier action with respect to water vapor. An increase in the thickness of the core layer A also brings about an increase in the wall thickness in the shoulder area of the blister. This thickness is likewise increased if a mixture of two COCs is used in the film, depending on their ratio used.

1. A multilayer polyolefin film composed of at least three layers, comprising I) a) a core layer A functioning as base layer and composed of at least one amorphous polyolefin and b) on the two sides, outer layers B and C composed of a mixture composed of polypropylene and of at least one amorphous polyolefin, or II) a) a core layer A composed of a mixture of at least one semicrystalline polyolefin and 5.0% by weight or more of at least one amorphous polyolefin, and b) two outer layers B and C which are identical or different, composed of a semicrystalline polyolefin and/or of a mixture composed of polypropylene and of at least one amorphous polyolefin.

2. The film as claimed in claim 1, wherein the amorphous polyolefin is a cycloolefin copolymer and/or a cycloolefinic polymer.

3. The film as claimed in claim 1, wherein the amorphous polyolefin is a copolymer composed of ethylene and/or of an α-olefin and of a cyclic, bicyclic, or polycyclic olefin.

4. The film as claimed in claim 1, wherein the amorphous polyolefin derives from at least one cyclic or polycyclic olefin of the following formulae I to VI 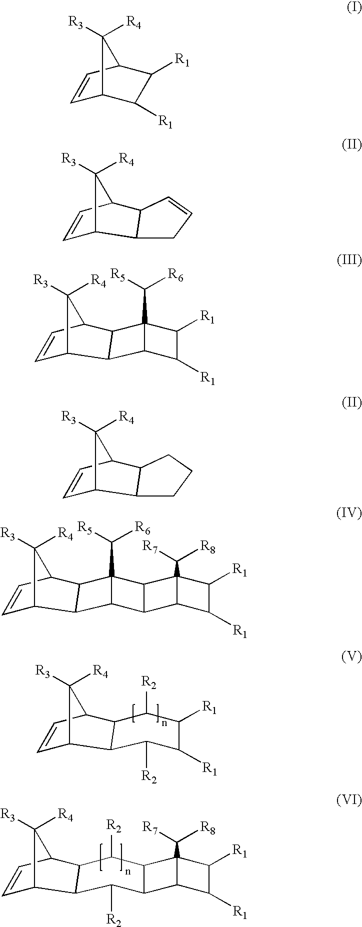
where R¹, R², R³, R⁴, R⁵, R⁶, R⁷, and R⁸ are identical or different and are a hydrogen atom or a C₁-C₂₀-hydrocarbon radical, such as a linear or branched C₁-C₈-alkyl radical, C₆-C₁₈-aryl radical, or C₇-C₂₀-alkylenearyl radical, or a cyclic or acyclic C₂-C₂₀-alkenyl radical, or form a saturated, unsaturated, or aromatic ring, where identical radicals R¹ to R⁸ have a different meaning in the various formulae I to VI, and where n assumes values from 0 to 5, and from 0 to 99.9% by weight based on the total weight of the cycloolefin copolymer, of polymerized units which derive from one or more acyclic olefins of the formula VII 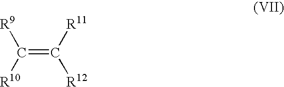
where R⁹, R¹⁰, R¹¹, and R¹² are identical or different and are a hydrogen atom, a linear, branched, saturated or unsaturated C₁-C₂₀-hydrocarbon radical, such as a C₁-C₈-alkyl radical or a C₆-C₁₈-aryl radical.

5. The film as claimed in claim 4, wherein the amorphous polyolefin is a cycloolefin copolymer which contains, based on its total weight, from 0 to 45% by weight of polymerized units which derive from one or more monocyclic olefins of the formula VIII 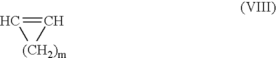
where m is a number from 2 to 10.

6. The film as claimed in claim 1, wherein the amorphous polyolefin is a copolymer composed of ethylene and norbornene.

7. The film as claimed in claim 1, wherein the proportion of amorphous polyolefin in a mixture composed of at least one semicrystalline polyolefin and of at least one amorphous polyolefin is from 10 to 50% by weight.

8. The film as claimed in claim 1, wherein the amorphous polyolefin has a glass transition temperature T_{g} in the range from 60 to 300° C., preferably from 70 to 250° C., in particular from 80 to 200° C., the Vicat softening point T_{V} (VST/B/120) is in the range from 70 to 200° C., preferably from 80 to 180° C., and the amorphous polyolefin has an average molecular weight Mw in the range from 1000 to 500 000.

9. The film as claimed in claim 1, wherein the thickness of the film is from 50 to 300 μm, and the thicknesses of the outer layers make up from 2.5 to 90% of the entire structure.

10. The film as claimed in claim 1, wherein the semicrystalline polyolefin present comprises a polymer composed of ethylene or of α-olefins or comprises copolymers of these.

11. A process for producing a multilayer polyolefin film composed of at least three layers, comprising I) a) a core layer A functioning as base layer and composed of at least one amorphous polyolefin and b) on the two sides, outer layers B and C composed of a mixture composed of polypropylene and of at least one amorphous polyolefin, or II) a) a core layer A composed of a mixture of at least one semicrystalline polyolefin and 5.0% by weight or more of at least one amorphous polyolefin, and b) two outer layers B and C which are identical or different, composed of a semicrystalline polyolefin and/or of a mixture composed of polypropylene and of at least one amorphous polyolefin, which comprises melting the film-forming polymers and/or polymer mixtures in an extruder, then extruding the melt(s) through a flat-film die, drawing off the resultant film on one or more rolls, whereupon it cools and solidifies, or extruding the melt(s) emerging from the extruder via an annular die, whereupon the melt(s) emerging from the extruder is/are extruded through an annular die, whereupon the resultant film is processed in a blown-film system to give the film, collapsed by way of rolls, and drawn off.

12. The process as claimed in claim 11, wherein the film is, if appropriate, stretched and/or heat-set and/or surface-treated.

13-14. (canceled)

15. Deep-thermoformed packaging or a pharmaceutical blister pack, produced from the multilayer polyolefin film as claimed in claim 1.

16. A laminated article, encompassing a multilayer polyolefin film as claimed in claim 1 with paper and/or cardboard and/or with one or more metal foils, and/or with other films composed of thermoplastic.

17. The process as claimed in claim 4, wherein 0.1 to 99.9% by weight, based on the total weight of the cycloolefin copolymer, of polymerized units is derived from one or more acyclic olefins of the formula VII.

18. The film as claimed in claim 6, wherein the proportion of amorphous polyolefin in a mixture composed of at least one semicrystalline polyolefin and of at least one amorphous polyolefin is from 15 to 40% by weight.

19. The film as claimed in claim 7, wherein the amorphous polyolefin has a glass transition temperature T_{g} in the range from 80 to 200° C., the Vicat softening point T_{V} (VST/B/120) is in the range from 80 to 180° C., and the amorphous polyolefin has an average molecular weight Mw in the range from 3,000 to 150,000.

20. The film as claimed in claim 18, wherein the thickness of the film is from 75 to 250 μm, and the thicknesses of the outer layers make up from 2.5 to 90% of the entire structure.

21. A thermoplastic packaging film which comprises the film as claimed in claim 1.

22. Pharmaceutical blister packs which comprises the film as claimed in claim 1.
